(19) United States
(12) Patent Application Publication
(10) Pub. No.: US 2020/0093178 A1
(43) Pub. Date: Mar. 26, 2020

(54) CARTRIDGE FOR AN AEROSOL GENERATING DEVICE AND METHOD FOR MAKING SAID CARTRIDGE

(71) Applicant: G.D SOCIETA' PER AZIONI, Bologna (IT)

(72) Inventors: Franco Serventi, Fornovo Di Taro (IT); Luca Federici, Bologna (IT)

(21) Appl. No.: 16/495,983

(22) PCT Filed: Mar. 27, 2018
(86) PCT No.: PCT/IB2018/052090

§ 371 Date: Sep. 20, 2019

(30) Foreign Application Priority Data
Mar. 27, 2017 (IT) 102017000033052

(51) Int. Cl. A24F 40/42; B29C 63/00; A24F 40/70; B29C 63/18; B65D 25/36; B65B 1/02; B65B 1/04

(52) U.S. Cl. CPC A24F 40/42; B29C 63/0069; A24F 40/70; B29L 2031/7414; B65D 25/36; B65B 1/02; B65B 1/04; B29C 63/18

(57) ABSTRACT

Cartridge for an aerosol generating device and method for making said cartridge is disclosed. The cartridge has:

a container which comprises a bottom, a lateral wall which rises from the bottom and an opening;

a liquid contained in the container;

a cap which closes the opening of the container; and

a coating which covers at least the lateral wall of the container (2) and which is made of a heat-shrinkable material.

### PRIORITY CLAIM

This application claims priority from the Italian Patent Application no. 102017000033052 filed on Mar. 27, 2017 the content of which is incorporated herein by reference.

### TECHNICAL FIELD

The present invention relates to a cartridge for an aerosol generating device and to a method for making said cartridge.

### PRIOR ART

Aerosol generating devices are known, which comprise a battery, an atomizer which is powered by the battery, and a cartridge containing a liquid. During use, the atomizer heats up the liquid contained in the cartridge and the vapour inhales the steam that is produced. Once the liquid contained in the cartridge is exhausted the latter is either recharged or replaced with a new cartridge.

A cartridge of a known type comprises: a container having a bottom, a tubular lateral wall that rises from the bottom and an opening; a liquid contained in the container; a cap that closes the opening of the container; an adhesive label that is glued to the lateral wall of the container and which covers the lateral wall of the container.

Said label is made of a smooth plastic material, is printed with drawings and/or lettering, and is glued to the outside of the container for aesthetic reasons and for identifying the brand of the cartridge. In particular, said label is wrapped around the lateral wall of the container by more than 360 degrees, thus creating an overlapping area of the label ends. However, it often happens that the label is glued without being correctly aligned or with unwanted wrinkles. Consequently, said cartridges may need to be discarded as they do not meet the imposed quality standards. In addition, the aforesaid overlapping area and the smooth plastic material with which the label is made can make the cartridge difficult to handle.

### DESCRIPTION OF THE INVENTION

The object of the invention is to provide a cartridge for an aerosol generating device and a method for making said cartridge that overcomes the aforesaid drawbacks.

This object is obtained by means of a cartridge and a method according to the attached claims.

### BRIEF DESCRIPTION OF THE DRAWINGS

The present invention will now be described with reference to the accompanying drawings, which illustrate some examples of non-limiting embodiments, wherein:

FIG. 1 is a perspective view of an embodiment of a cartridge object of the present invention;

FIG. 2 is a bottom view of the cartridge of FIG. 1;

FIGS. 3A-3F are perspective views or cross-sectional views of respective operating steps of the method, also the object of the present invention, for making the cartridge of FIG. 1;

FIG. 4 is a cross-sectional view of a further embodiment of a cartridge object of the present invention.

### PREFERRED EMBODIMENTS OF THE INVENTION

With reference to the accompanying Figures, a cartridge for an aerosol generating device is denoted with numeric reference 1.

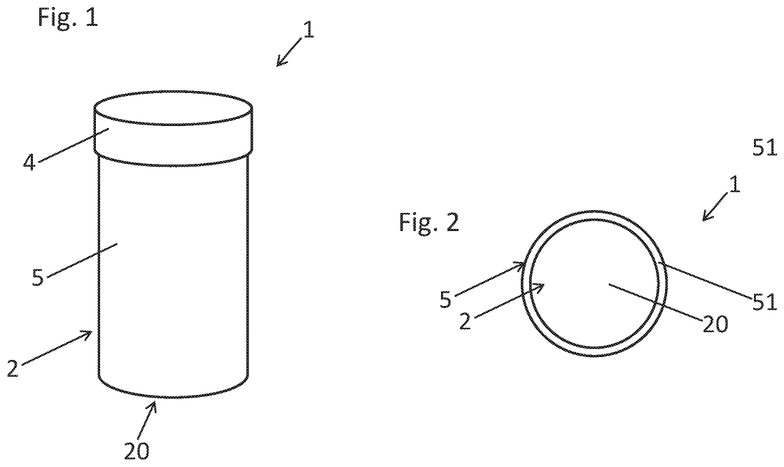

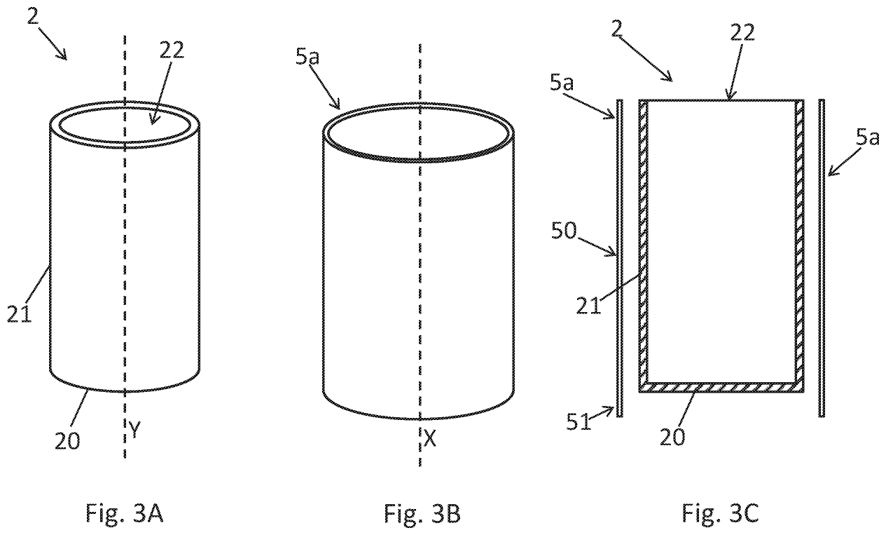

With reference to FIGS. 1-3F, a first preferred embodiment of the cartridge 1 is described in the following.

The cartridge 1 comprises: a container 2 that comprises a bottom 20, a lateral wall 21 which rises from the bottom 20 and an opening 22; a liquid 3 (for example, flavoured with tobacco or fruit) contained in the container 2; a cap 4 which closes the opening 22 of the container 2; a coating 5 which covers at least a part of the lateral wall 21 of the container 2 and that is made of a heat-shrinkable material.

The fact that the coating 5 is made of a heat-shrinkable material, makes the adhesion of the coating 5 to the container 2 extremely simple and precise. Therefore, with respect to the known art cartridge which provides for the coating of the container by means of an adhesive label, the coating 5 of the proposed cartridge 1 advantageously reduces (if not eliminates) the number of cartridges 1 to be discarded when they do not meet the imposed quality standards. Consequently, the production costs for the cartridge 1 are reduced with respect to the known ones. In addition, the coating 5 made of a heat-shrinkable material provides a good grip for the cartridge 1. Advantageously, said cartridge 1 is easily handled.

The coating 5 is preferably made of a rubberized material (i.e. is made of a material which allows a good grip).

Preferably, the coating 5 completely covers the inside of the lateral wall 21 of the container 2. The container 2 can be made of a plastic material or stainless steel or a glass material.

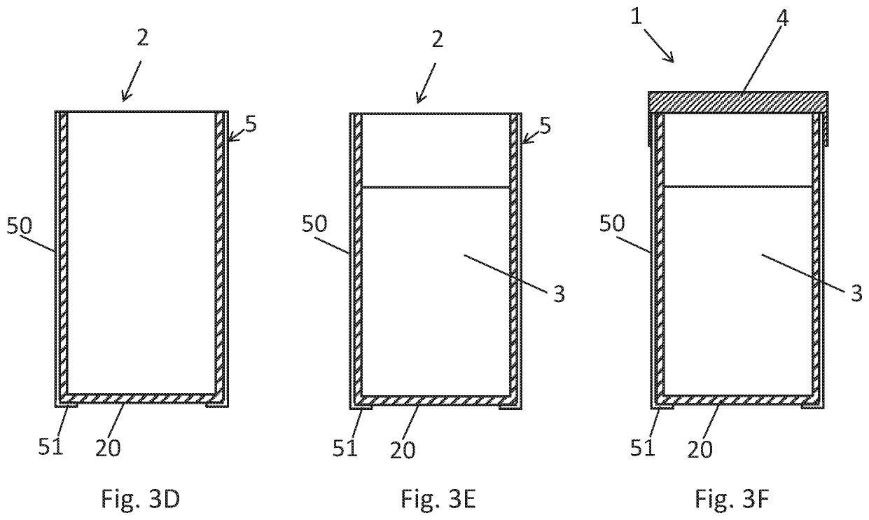

With reference to FIG. 3A, the container 2 has a longitudinal development along a development axis Y and has a circular cross-section. Preferably, the container 2 has a constant cross-section throughout its development.

The opening 22 of the container 2 is opposite to the bottom 20 of the container 2.

With particular reference to FIGS. 3D-3F, the coating 5 preferably comprises a first sleeve-shaped portion 50 which covers the lateral wall 21 of the container 2 and a second annular-shaped portion (preferably circular) which covers (preferably partially) the bottom 20 of the container 2.

Advantageously, the at least partial coating of the bottom 20, provides a greater protection for the cartridge 1.

Preferably, the first portion 50 and the second portion 51 of the coating 5 are in a single body. In other words, the second portion 51 covers the bottom 20 of the container 2 at least at the peripheral edge of the bottom 20.

Consequently, the edge between the bottom 20 of the container 2 and the lateral wall 21 of the container 2 is advantageously protected (said edge is not protected in the known art cartridge).

The coating 5 is made of a plastic material. With particular reference to FIGS. 3D-3F, the coating 5 has a longitudinal development along a development axis X. The coating 5 and the container 2 are coaxial.

The coating 5 is obtained by the heat-shrinking of a tubular element 5a. Advantageously, unlike the known art cartridge wherein the label is wrapped by more than 360 degrees around the lateral wall of the container thus creating an overlapping area of the label ends, the proposed cartridge 1 does not have said overlapping area. Advantageously, the cartridge 1 has better handling features. In addition, the cartridge 1 provides a better seal of the cap 4 (the cap in the known art cartridge provides less of a seal due to the overlapping area of the label ends).

The coating 5 is preferably free of joining lines (in particular, devoid of joining lines parallel to the development axis X of the coating 5). In other words, the tubular element 5a which forms the coating 5 by heat-shrinking is preferably devoid of joining lines.

The fact that the coating 5 is devoid of the aforementioned joining lines further ensures a better seal of the cap 4.

Preferably, the tubular element 5a has a constant thickness. Consequently, the coating 5 has a constant thickness.

According to a non-illustrated embodiment, the coating 5 could also have a joining line substantially parallel to the development axis X of the coating 5.

The cap 4 can be made of a plastic or metal material. Preferably, the cap 4 is made of a plastic material.

Even more preferably, cap 4 is made of an elastically deformable material (for example, silicone). Advantageously, the sealing of the opening 22 of the container 2 is guaranteed.

Preferably, the cap 4 comprises at least one retaining flap (not shown) engaging in the lateral wall 21 of the container 2 so as to close the opening 22 of the container 2 in a tight-seal manner. Advantageously, the tight-seal closing of the opening 22 of the container 2 is guaranteed.

The cap 4 can comprise a lateral wall 40 (preferably having a circular cross-section) and a base wall 41 from which the lateral wall 40 raises. The base wall 41 faces the opening 22 of the container 2. The retaining flap can develop from the inner surface of the lateral wall 40 of the cap 4. In particular, the retaining flap of the cap 4 engages in the outer surface of the lateral wall 21 of the container 2 (the retaining flap is arranged between the lateral wall 21 of the container 2 and the lateral wall 40 of the cap 4).

The retaining flap is preferably made of an elastically deformable material.

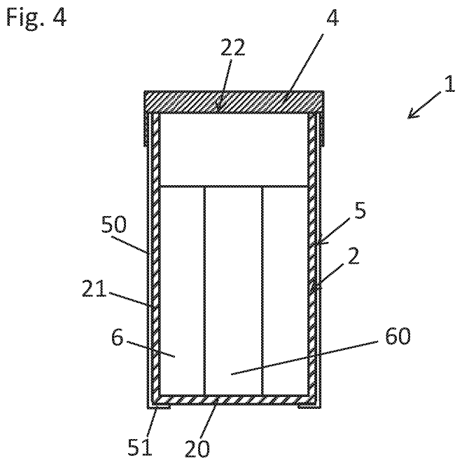

With reference to the embodiment of the cartridge 1 shown in FIG. 4, the same differs from that of FIG. 3F in that it comprises an absorbent element 6 which is arranged in the container 2 and which holds the liquid 3.

The absorbent element 6 can be made of cotton. In addition, the absorbent element 6 can comprise a cavity 60, for example a through cavity. With particular reference to FIG. 4, the absorbent element 6 is shaped as a hollow cylinder.

With particular reference to FIGS. 3A-3F, a preferred embodiment of the method of the present invention is described in the following in order to make one of the embodiments of said cartridge 1.

The method comprises the steps of:
providing a container 2 which comprises a bottom wall 20, a lateral wall 21 rising from the bottom 20, and an opening 22 (FIG. 3A);
providing a tubular element 5a (preferably having a circular cross-section) which has a longitudinal development along a development axis X and is made of a heat-shrinkable material (FIG. 3B);
arranging the tubular element 5a and the container 2 so that, the tubular element 5a and the lateral wall 21 of the container 2 are facing each other (FIG. 3C);
heating the tubular element 5a until the tubular element 5a adheres to at least a part of the lateral wall 21 of the container 2 thus forming a coating 5 (FIG. 3D);
injecting a liquid 3 through the opening 22 of the container 2 (FIG. 3E);
closing the opening 22 of the container 2 (FIG. 3F).

The proposed method allows the tubular element 5a to adhere to the container 2 thus minimizing, if not eliminating, the probability of an incorrect arrangement of the tubular element 5a. Advantageously, the number of cartridges 1 discarded is greatly reduced when the coating 5 does not meet the required parameters. Moreover, the proposed method is extremely simple.

The step of arranging the tubular element 5a and the container 2 so that, the tubular element 5a and the lateral wall 21 of the container 2 are facing each other, provides for the tubular element 5a to be arranged outside the container 2.

Preferably, with reference to FIGS. 3C-3D, the step of arranging the tubular element 5a and the container 2 so that, the tubular element 5a and the lateral wall 21 of the container 2 are facing each other comprises the step of arranging the container 2 inside the tubular element 5a so that:
a first portion 50a of the tubular element 5a faces the lateral wall 21 of the container 2 so that, after heating the tubular element 5a, said first portion 50a adheres to the container 2 at the lateral wall 21 forming a first portion 50 of the coating 5;
a second portion 51a of the tubular element 5a protrudes beyond the bottom 20 of the container 2 so that, after heating the tubular element 5a, said second portion 51a adheres to the container 2 at the bottom 20 thus forming a second portion 51 of the coating 5.

Advantageously, in a single operation, the tubular element 5a adheres to both the lateral wall 21 of the container 2 and to the bottom 20 of the container 2. Consequently, a cartridge 1 is easily and quickly made wherein the coating provides greater protection to the container 2.

With further reference to FIG. 3C, the step of arranging the tubular element 5a and the container 2 so that, the tubular element 5a and the lateral wall 21 of the container 2 are facing each other comprises the step of arranging the container 2 inside the tubular element 5a and coaxial with the tubular element 5a.

Advantageously, when the tubular element 5a adheres to the lateral wall 21 of the container 2, it will adhere evenly to the entire lateral wall 21.

Preferably, the step of heating the tubular element 5a until the tubular element 5a adheres to at least a part of the lateral wall 21 of the container 2 is performed before the step of closing the opening 22 of the container 2. Advantageously, a better seal of the closure is provided.

In fact, supposing to close the opening 22 of the container 2 with a cap 4 engaging the container 2, said cap 4 will have better grip if, between the latter and the container 2, the coating 5 is located (due to the fact that the coating 5 is made of a plastic and/or rubberized material).

The step of heating the tubular element 5a until the tubular element 5a adheres to at least the lateral wall 21 of the container 2 may comprise the steps of: heating the tubular element 5a to a predetermined temperature forming the coating 5 and, successively, waiting for the cooling or cool the coating 5 until the same is hardened.

The step of injecting liquid 3 through the opening 22 of the container 2 is performed after the step of heating the tubular element 5a until the tubular element 5a adheres to at least the lateral wall 21 of the container 2.

In the case wherein the cartridge 1 to be made comprises the absorbent element 6, then the method comprises the step of arranging the absorbent element 6 in the container 2. Preferably, said step of arranging the absorbent element 6 in the container 2 is performed before the step of injecting the liquid 3 in the container 2.

An aerosol generating device comprises: a cartridge 1 according to one of said embodiments; an atomizer that is connectable to the cartridge 1 to heat the liquid 3 contained in cartridge 1 and to produce aerosol; a battery that powers the atomizer; an aerosol output that is in fluid communication with the cartridge for receiving aerosol from cartridge 1 and allow the output of aerosol from the aerosol generating device.

1. A cartridge (1) for an aerosol generating device, comprising:
a container (2) which comprises a bottom (20), a lateral wall (21) which rises from the bottom (20) and an opening (22);
a liquid (3) contained in the container (2);
a cap (4) which closes the opening (22) of the container (2); and
a coating (5) which covers at least a part of the lateral wall (21) of the container (2);
wherein the coating (5) is made of a heat-shrinkable material which has been heated until it adheres to at least a part of the lateral wall (21) of the of the container (2).

2. The cartridge (1) according to claim 1, wherein the coating (5) comprises a first portion (50) which is sleeve-shaped and which covers the lateral wall (21) of the container (2) and a second portion (51) which is annular-shaped and which covers the bottom (20) of the container (2).

3. The cartridge (1) according to claim 2, wherein the first portion (50) and the second portion (51) of the coating (5) are in a single body.

4. The cartridge (1) according to claim 1, wherein the coating (5) is obtained by the heat-shrinking of a tubular element (5a).

5. The cartridge (1) according to claim 1, wherein the cap (4) is made of an elastically deformable material.

6. A method for making a cartridge (1) for an aerosol generating device, comprising the steps of:
providing a container (2) which comprises a bottom (20), a lateral wall (21) which rises from the bottom (20) and an opening (22);
providing a tubular element (5a) which has a longitudinal development along a development axis (X) and which is made of a heat-shrinkable material;
arranging the tubular element (5a) and the container (2) so that the tubular element (5a) and the lateral wall (21) of the container (2) are facing each other;
heating the tubular element (5a) until the tubular element (5a) adheres to at least a part of the lateral wall (21) of the container (2) forming a coating (5);
injecting a liquid (3) through the opening (22) of the container (2); and
closing the opening (22) of the container (2).

7. The method according to claim 6, wherein the step of arranging the tubular element (5a) and the container (2) so that the tubular element (5a) and the lateral wall (21) of the container (2) are facing each other comprises a step of arranging the container (2) inside the tubular element (5a) so that:
a first portion (50a) of the tubular element (5a) faces the lateral wall (21) of the container (2) so that, after heating the tubular element (5a), said first portion (50a) adheres to the container (2) at the lateral wall (21) forming a first portion (50) of the coating (5);
a second portion (51a) of the tubular element (5a) protrudes beyond the bottom (20) of the container (2) so that, after heating the tubular element (5a), said second portion (51a) adheres to the container (2) at the bottom (20) forming a second portion (51) of the coating (5).

8. The method according to claim 6, wherein the container (2) has a longitudinal development along a development axis (Y) and wherein the step of arranging the tubular element (5a) and the container (2) so that the tubular element (5a) and the lateral wall (21) of the container (2) are facing each other comprises the step of arranging the container (2) inside the tubular element (5a) and coaxial with the tubular element (5a).

9. The method according to claim 6, wherein the step of heating the tubular element (5a) until the tubular element (5a) adheres to at least a part of the lateral wall (21) of the container (2) is performed before the step of closing the opening (22) of the container (2).

10. The method according to claim 6, wherein the step of injecting the liquid (3) through the opening (22) of the container (2) is performed after the step of heating the tubular element (5a) until the tubular element (5a) adheres to at least a part of the lateral wall (21) of the container (2) forming a coating (5).

11. The method according to claim 6, wherein the step of arranging the tubular element (5a) and the container (2) so that the tubular element (5a) and the lateral wall (21) of the container (2) are facing each other comprises arranging the container (2) inside the tubular element (5a) so that:
a first portion (50a) of the tubular element (5a) faces the lateral wall (21) of the container (2) so that, after heating the tubular element (5a), said first portion (50a) adheres to the container (2) at the lateral wall (21) forming a first portion (50) of the coating (5); and
a second portion (51a) of the tubular element (5a) protrudes beyond the bottom (20) of the container (2) so that, after heating the tubular element (5a), said second portion (51a) adheres to the container (2) at the bottom (20) thus forming a second portion (51) of the coating (5).

12. The method according to claim 6, wherein the step of arranging the tubular element (5a) and the container (2) so that the tubular element (5a) and the lateral wall (21) of the container (2) are facing each other comprises arranging the container (2) inside the tubular element (5a) and coaxial with the tubular element (5a).
